(19) United States
(12) Patent Application Publication
(10) Pub. No.: US 2014/0054154 A1
(43) Pub. Date: Feb. 27, 2014

(54) ULTRA-THIN COMPUTER INPUT DEVICE

(71) Applicant: Pei-Yu HSU, Zhongli City (TW)

(72) Inventor: Pei-Yu HSU, Zhongli City (TW)

(73) Assignee: SIN MEI ELECTRONICS CO., LTD., Guishan Township (TW)

(21) Appl. No.: 13/592,990

(22) Filed: Aug. 23, 2012

(51) Int. Cl. H01H 1/10

(52) U.S. Cl. 200/512

(57) ABSTRACT

An ultra-thin computer input device includes a substrate carrying a circuit layout having sets of comb-like contact portions arranged in a staggered manner, and an outer membrane arranged on the substrate and provided with conducting portions corresponding to the comb-like contact portions of the circuit layout of the substrate and electrically insulative beads located on a part of the bottom side of each conducting portion and stopped against the comb-like contact portions of the circuit layout of the substrate. Because the invention eliminates the use of metal domes, rubber domes or scissor-type linking elements, the thickness and number of component parts of the ultra-thin computer input device can be greatly reduced.

### BACKGROUND OF THE INVENTION

1. Field of the Invention

The present invention relates to computer-input technologies and more particularly, to an ultra-thin computer input device comprising a substrate carrying a circuit layout and an outer membrane having electrically insulative, elastic domes located on a bottom side of each of bottom multiple conducting portions thereof and stopped against the circuit layout of the substrate for enabling the circuit layout to be selectively triggered by the conducting portions to produce corresponding signals upon pressing of the outer membrane by a user at selected location. The design of the substrate and the outer membrane enables the whole thickness of the computer input device to be significantly reduced.

2. Description of the Related Art

With the prevalence of electronic devices and rapid progress of wireless transmission technology, a growing number of wireless electronic devices, such as remote controller, mobile phone, portable computer, etc. appear in our society and life. The wireless transmission function of a wireless device is adapted for transmitting signals to a wireless receiving device. Therefore, a wireless device generally provides an input device for purposes of facilitating user's operation of the wireless device.

Because of the demand on the use of structural and dimensional limitations, different electronic devices may be equipped with a different input device. By no matter what kind of designs, it is the market trend to create wireless electronic devices having light, thin, compact and small characteristics. However, the limitations of conventional techniques cannot allow the thickness of a computer input device to he significantly reduced.

A conventional notebook computer keyboard generally comprises a set of key switches. As illustrated in. FIG. 6, each key switch of the keyboard comprises a key cap A, a frame plate A2, a link A1 coupled between the key cap A and the frame plate A2, a cushion pad B arranged at the top side of the frame plate A2, an elastic plunger B1 fastened to the bottom wall of the key cap A above the cushion pad B, a bottom plate D disposed below the frame plate A2, and a membrane circuit board C set between the frame plate A2 and the bottom plate D. The membrane circuit board C comprises two thin films C1, two silver paste printed circuits C3 respectively located on the thin films C1 and facing toward each other, and a spacer layer C2 set between the two thin films C1 to keep the two silver paste printed circuits C3 apart. When a user presses the key cap A to move the link A1, the elastic plunger B1 is lowered through an opening on the frame plate A2 and forced against the membrane circuit board C, causing the two silver paste printed circuits C3 to contact each other and to further produce a corresponding signal. When the user releases the finger from the key cap A, the elastic plunger B1 returns to its former shape, returning the key cap A to its former position.

Because the link A1 must be pivotally coupled to the frame plate A2 and requires some vertical space for movement, the elastic plunger B1 also requires some vertical space for elastic deformation, and the membrane circuit board C is a multilayer structure having a certain thickness, the thickness of notebook computer keyboard of this design cannot be significantly reduced. Further, the assembly process of this design of notebook computer keyboard is complicated, and its manufacturing cost is also high.

FIG. 7 illustrates a key switch structure for small electronic device, such as mobile telephone or remote controller. This design of key switch structure comprises a circuit board E carrying a circuit E1 with multiple pairs of contacts E11, annular insulative members E2 respectively arranged on the circuit E1 of the circuit board E around each of the multiple pairs of contacts E11, a plurality of metal domes E3 respectively supported on the annular insulative members E2, a support layer F spaced above the circuit board E, a plurality of plungers F1 located on the bottom wall of the support layer F and respectively kept in contact with the metal domes E3, and a plurality of keys F2 respectively arranged on the top wall of the support layer F corresponding to the plungers F1. When a user presses one key F2 to lower the support layer F, the associating plunger F1 will be lowered against the associating metal dome E3 to deform the associating metal dome E3 elastically and to force the associating metal dome E3 into contact with the associating pair of contacts E11 of the circuit E1 of the circuit board E, causing the circuit E1 to produce a corresponding signal. When the user releases the finger from the key F2, the associating metal dome E3 will immediately returns to its former shape, thereby returning the support layer F to its former position.

According to the design of the aforesaid key switch structure, the metal domes E3 require some vertical space for elastic deformation and the arrangement of the support layer F, plungers F1 and keys F2 also increases the thickness of the key switch structure. Further, the annular insulative members E2 are adapted to keep the metal domes E3 normally apart from the respective contacts E11 of the circuit E1 of the circuit board E, allowing each metal dome E3 to be elastically deformed and forced into contact with the associating pair of contacts E11 of the circuit E1 of the circuit board E by the associating plunger F1 upon pressing the respective key F2. Moreover, the arrangement of the annular insulative members E2 also greatly increases the thickness of the key switch structure. Further, the assembly process of this design of key switch structure is complicated, and its manufacturing cost is also high.

In actual use, the aforesaid prior art input devices have drawbacks as follows:
(1) The frame plate A2 and membrane circuit board C, or the support layer F, plungers F1, keys F2 and annular insulative members E2 are requisite component parts, their arrangement greatly increases the number of layers and structural thickness of the input device; the link A1 and elastic plunger B1 or the metal domes E3 require some vertical space for elastic deformation, and therefore, it is not possible to reduce the thickness of the input device.
(2) Due to the use of a large number of requisite component parts, the assembly procedure of the product is complicated, resulting in high cost.

Therefore, it is desirable to provide a computer input device, which eliminates the drawbacks of large thickness, complicated assembly procedure and high cost.

### SUMMARY OF THE INVENTION

The present invention has been accomplished under the circumstances in view. It is therefore the main object of the present invention to provide an ultra-thin computer input device, which eliminates the drawbacks of conventional input device designs.

To achieve this and other objects of the present invention, an ultra-thin computer input device comprises a substrate and an outer membrane. The substrate carries a circuit layout on the top surface thereof. The circuit layout comprises a plurality of electrode sets raised to the top surface of the substrate. Each electrode set comprises a first electrode and a second electrode. The first electrode and the second electrode each comprise a comb-like contact portion. The comb-like contact portion of the first electrode faces toward the comb-like contact portion of the second electrode in such a manner that the two comb-like contact portions of the first electrode and the second electrode are disposed in a staggered manner with a plurality of gaps left therebetween. The outer membrane is arranged on the substrate over the circuit layout, comprising a plurality of conducting portions located on the bottom surface thereof corresponding to the comb-like contact portions of the first electrodes and second electrodes of the electrode sets of the circuit layout of the substrate, and a plurality of electrically insulative beads located on a part of the bottom side of each conducting portion and stopped against the comb-like contact portions of the first electrodes and second electrodes of the electrode sets of the circuit layout of the substrate. Thus, when a user gives a downward pressure to the outer membrane corresponding to one conducting portion, the respective conducting portion will be curved downwards to touch the first electrode and second electrode of the corresponding electrode set of the circuit layout of the substrate, causing the circuit layout of the substrate to produce a corresponding signal.

Further, because the substrate simply carries a circuit layout of electrode sets and the outer membrane simply provides conducting portions with electrically insulative beads, the thickness of the ultra-thin computer input device is the combined height of the substrate, the circuit layout of electrode sets, the outer membrane, the conducting portions and the electrically insulative beads. Because the invention eliminates the use of metal domes, rubber domes or scissor-type linking elements and because the height of the electrically insulative beads is much smaller than the distance of movement of a metal dome, rubber dome or scissor-type linking element, the thickness and number of component parts of the ultra-thin computer input device can be greatly reduced.

Further, a spacer layer that has openings for accommodating the electrically insulative beads and conducting portions of the outer membrane can be set between the substrate and the outer membrane to support the outer membrane above the substrate in shape without significantly increasing the total thickness of the ultra-thin computer input device, making a significant difference between touching the area of the outer member corresponding to the conducting portions and the other area of the outer member beyond the conducting portions.

Further, a support layer can be set between the substrate and the spacer layer to support the spacer layer and the outer membrane on the substrate, keeping the electrically insulative beads of the outer membrane in contact with the comb-like contact portions of the first electrodes and second electrodes of the electrode sets of the substrate lightly, avoiding causing elastic fatigue of the electrically insulative beads and prolonging the service life of the ultra-thin computer input device.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an elevational view of an ultra-thin computer input device in accordance with the present invention.

FIG. 2 is an exploded view of the ultra-thin computer input device in accordance with the present invention.

FIG. 3 is a schematic exploded view of a part of the ultra-thin computer input device in accordance with the present invention.

FIG. 4 is a schematic sectional partial view of the ultra-thin computer input device in accordance with the present invention.

FIG. 5 is a schematic sectional view of the present invention showing the outer membrane of the ultra-thin computer input device pressed.

FIG. 6 is a schematic sectional partial view of conventional notebook computer keyboard.

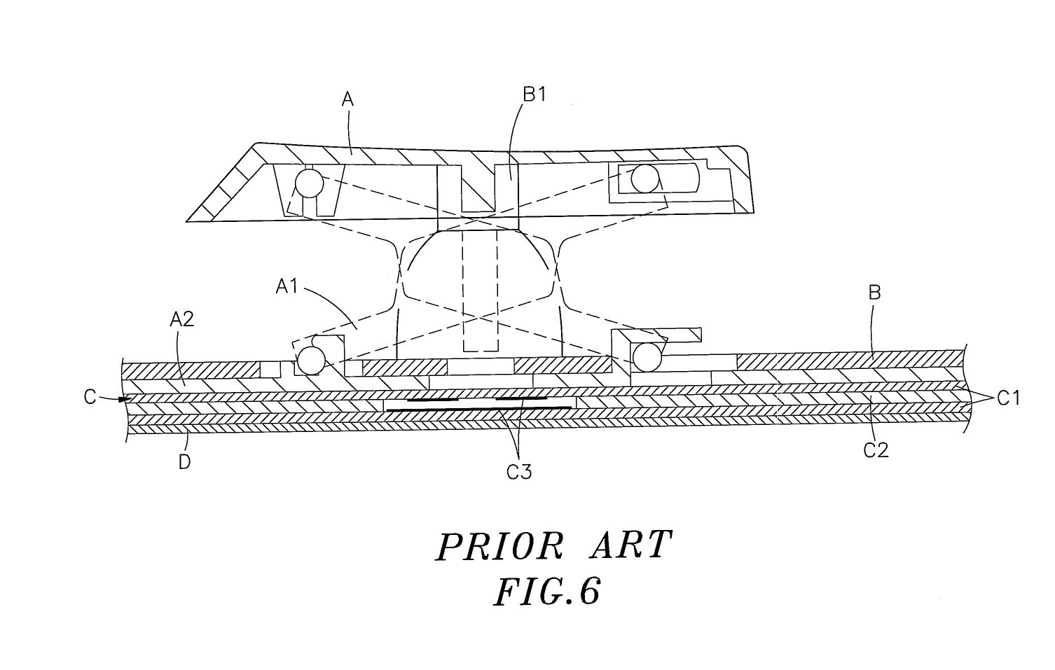

FIG. 7 is a schematic sectional view of a conventional key switch structure for small electronic device.

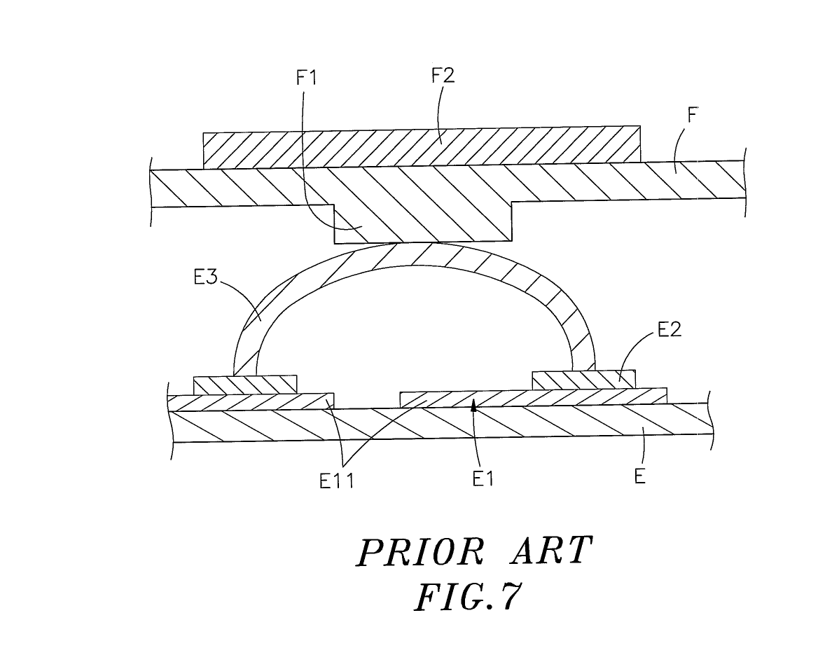

### DETAILED DESCRIPTION OF THE PREFERRED EMBODIMENT

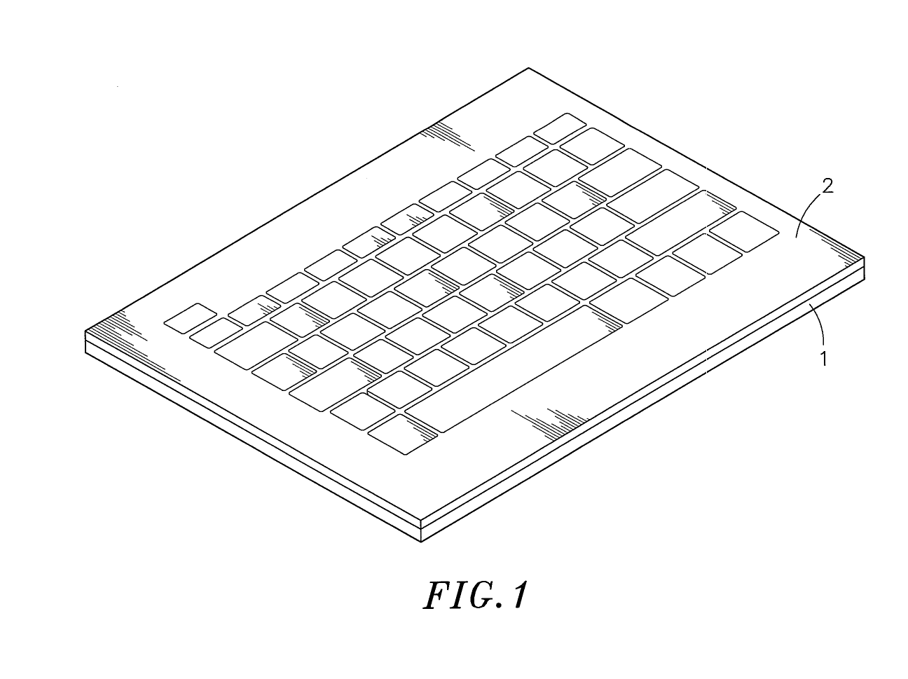

Referring to FIGS. 1-3, an ultra-thin computer input device in accordance with the present invention is shown. The ultra-thin computer input device comprises a substrate 1, and an outer membrane 2.

The substrate 1 carries thereon a circuit layout, which comprises multiple electrode sets 11 raised to the top surface of the substrate 1. Each electrode set 11 comprises a first electrode 111 and a second electrode 112. Each of the first electrode 111 and the second electrode 112 comprises a comb-like contact portion 113 formed of multiple fingers 1131. The comb-like contact portion 113 of the first electrode 111 faces toward the comb-like contact portion 113 of the second electrode 112 in such a manner that the fingers 1131 of the two comb-like contact portions 113 are disposed in a staggered manner with a gap 114 left between each finger 1131 of the comb-like contact portion 113 of the first electrode 111 and each adjacent finger 1131 of the comb-like contact portion 113 of the second electrode 112.

The outer membrane 2 is arranged on the top side of the substrate 1 over the circuit layout of the electrode sets 11, comprising a plurality of conducting portions 21 located on the bottom surface thereof corresponding to the comb-like contact portions 113 of the first electrodes 111 and second electrodes 112 of the electrode sets 11 of the substrate 1, and a plurality of electrically insulative beads 211 located on the bottom side of each of the conducting portions 21 and stopped against the comb-like contact portions 113 of the first electrodes 111 and second electrodes 112 of the electrode sets 11 of the substrate 1. The conducting portions 21 are made of an electrically conductive material, such as carbon film, silver paste, or copper foil. The electrically insulative beads 211 are elastically compressible and made of an electrically insulative elastic material (such as rubber or silicon rubber).

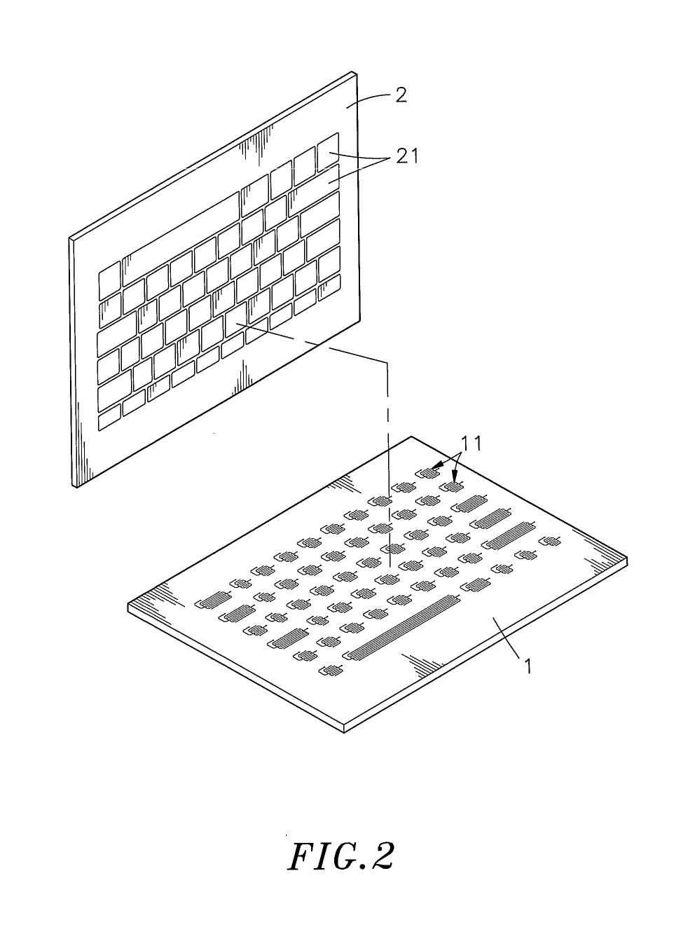

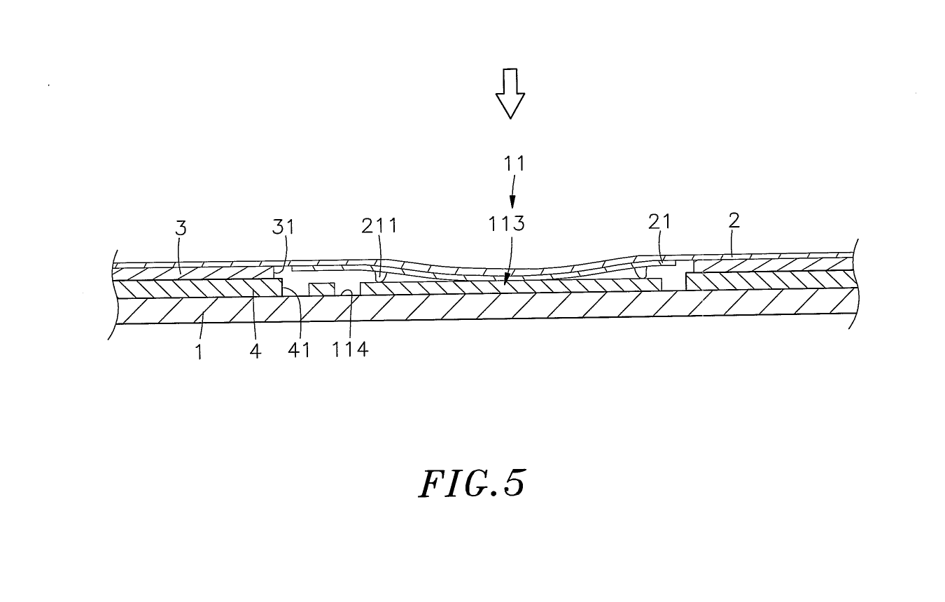

Referring to FIGS. 4 and 5 and FIGS. 2 and 3 again, the outer membrane 2 is made of a flexible or elastic material. When the outer membrane 2 is placed on the substrate 1, the electrically insulative beads 211 of the conducting portions 21 are respectively supported on the respective comb-like contact portions 113 of the first electrodes 111 and second electrodes 112 of the electrode sets 11 of the substrate 1, avoiding a short circuit between the conducting portions 21 and the comb-like contact portions 113. Further, when a user rests the hands on the top side of the outer membrane 2 and imparts a downward pressure to a particular area of the outer membrane 2, the electrically insulative beads 211 of the corresponding conducting portion 21 will be tilted or elastically deformed, causing the corresponding conducting portion 21 to curve downwards and to touch the comb-like contact portions 113 of the first electrode 111 and second electrode 112 of the corresponding electrode set 11 and producing a corresponding signal. The ultra-thin computer input device of the present invention is practical for use in a notebook computer, telephone, mobile telephone, PDA, remote controller, or any of a variety of other electronic devices.

The invention simply uses the substrate 1 and the outer membrane 2 to constitute the input device, the thickness of the input device is the combined height of the substrate 1, circuit layout of electrode sets 11, outer membrane 2, conducting portion 21 and electrically insulative beads 211. The substrate 1, the circuit layout of electrode sets 11 and the outer membrane 2 are requisite components. Further, the outer membrane 2 is a thin film member. Further, the substrate 1 can be a hard circuit board, flexible printed circuit board or membrane PC board having a small thickness. Because the invention eliminates the use of metal domes, rubber domes or scissor-type linking elements, no additional vertical space for elastic deformation is needed. Further, because the invention does not require any additional spacer layer to keep the conducting portions 21 of the outer membrane 2 normally apart from the circuit layout of electrode sets 11 of the substrate 1, the structure of the ultra-thin computer input device is simplified. Further, carbon film is used to make the conducting portions 21 of the outer membrane 2 for the advantages of being adjustable for height and low cost. Further, the arrangement of the electrically insulative beads 211 on the bottom side of the conducting portions 21 of the outer membrane 2 does not increase much the thickness of the outer membrane 2. Therefore, the thickness as well as the manufacturing cost of the computer input device can be minimized.

Further, the substrate 1 can be a bakelite board, glass fiber board, flexible PC board, or plastic board. Further, the circuit layout of electrode sets 11 can be made with copper foil or silver paste. However, because the fabrication of the substrate 1 and the circuit layout of electrode sets 11 is of the known art, no further detailed description in this regard is necessary.

Referring to FIGS. 4 and 5 and FIGS. 2 and 3 again, a spacer layer 3 can be provided between the substrate 1 and the outer membrane 2. The spacer layer 3 has a plurality of openings 31 for accommodating the electrically insulative beads 211 and conducting portions 21 of the outer membrane 2. Thus, the spacer layer 3 effectively support the outer membrane 2 above the substrate 1 in shape without significantly increasing the total thickness of the ultra-thin computer input device, making a significant difference between touching the area of the outer member 2 corresponding to the conducting portions 21 and the other area of the outer member 2 beyond the conducting portions 21. Thus, a user can operate the ultra-thin computer input device to input a large amount of data by means of the sense of touch without keeping the eyes on the outer member 2. Further, the arrangement of the spacer layer 3 between the substrate 1 and the outer membrane 2 relatively increases the stroke of the conducting portions 21 to contact the respective first electrodes 111 and second electrodes 112 of the respective electrode sets 11, and the user can get a significant sense of touch to know that he(she) has touched and pressed the correct area of the outer membrane 2. Further, the spacer layer 3 can be a transparent, semitransparent or opaque thin film that does not increase much the total thickness of the ultrathin computer input device.

Further, the spacer layer 3 can be an one-piece sheet member sandwiched between the substrate 1 and the outer membrane 2. Alternatively, the spacer layer 3 can be formed of multiple strips adhered between the substrate 1 and the outer membrane 2. Further, the thickness of the spacer layer 3 can be adjusted to meet user needs.

Further, English alphabets, Chinese phonetic alphabets, symbols and/or other signs can be made on the top surface of the outer membrane 2 using coating, strike-through, lenticular printing, laser die-cutting, foil-stamping, embossing, debossing, and/or engraving techniques.

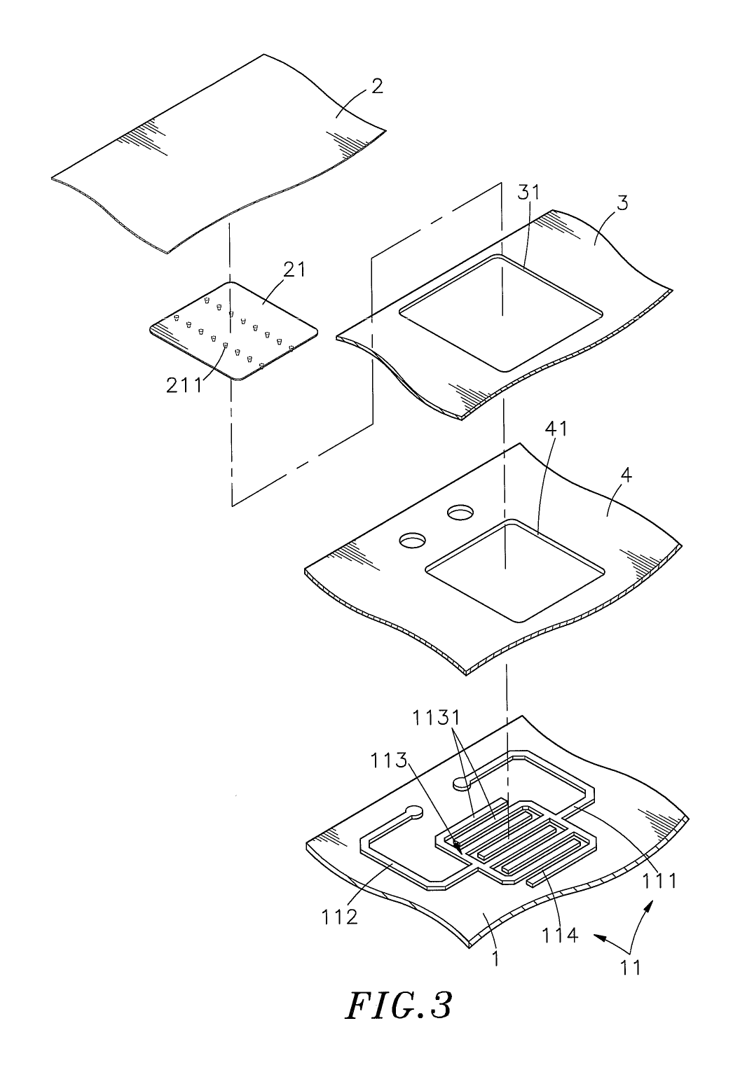

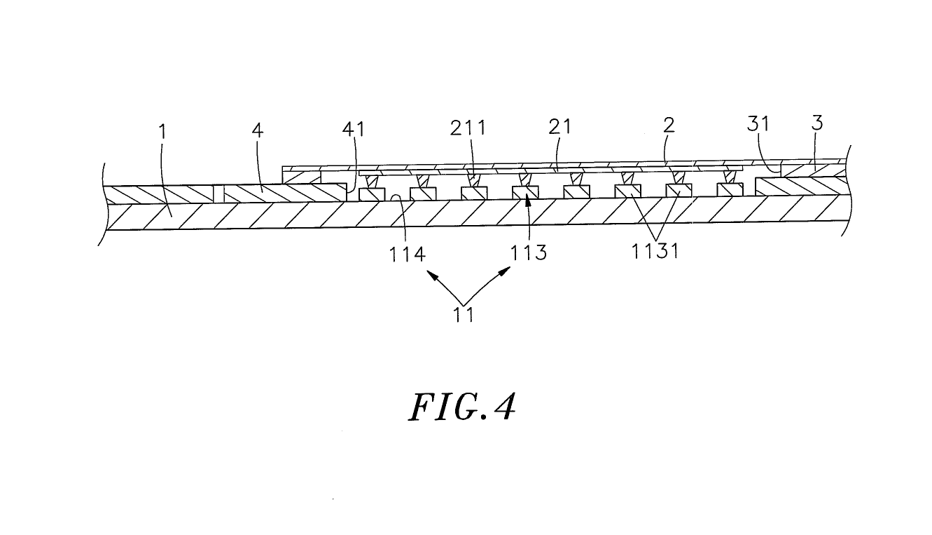

Referring to FIGS. 3 and 4 again, a support layer 4 may be set between the substrate 1 and the spacer layer 3. The support layer 4 has a plurality of openings 41 corresponding to the openings 31 of the spacer layer 3 for accommodating the electrically insulative beads 211 and conducting portions 21 of the outer membrane 2. Because the electrically insulative beads 211 of the outer membrane 2 are directly stopped against the comb-like contact portions 113 of the first electrodes 111 and second electrodes 112 of the electrode sets 11 of the substrate 1 to bear the weight of the outer membrane 2, an elastic fatigue will be resulted very easily. By means of using the support layer 4 to support the spacer layer 3 and the outer membrane 2 on the substrate 1, the electrically insulative beads 211 of the outer membrane 2 can be kept in contact with the comb-like contact portions 113 of the first electrodes 111 and second electrodes 112 of the electrode sets 11 of the substrate 1 lightly, avoiding causing elastic fatigue of the electrically insulative beads 211 and prolonging the service life of the ultra-thin computer input device.

In conclusion, the ultra-thin computer input device of the present invention, in actual use, has the advantages and features as follows:
1. The conducting portions 21 of the outer membrane 2 respectively face toward the comb-like contact portions 113 of the first electrodes 111 and second electrodes 112 of the electrode sets 11 of the substrate 1 and the electrically insulative beads 211 of the outer membrane 2 are directly stopped against the comb-like contact portions 113 of the first electrodes 111 and second electrodes 112 of the electrode sets 11 of the substrate 1; when a user gives a downward pressure to the outer membrane 2 corresponding to one conducting portion 21, the respective conducting portion 21 will be curved downwards to touch the first electrode 111 and second electrode 112 of the corresponding electrode set 11 of the substrate 1, causing the circuit layout of the substrate 1 to produce a corresponding signal.
2. The substrate 1 simply carries a circuit layout of electrode sets and the outer membrane 2 simply provides conducting portions 21 with electrically insulative beads 211, the thickness of the ultra-thin computer input device is the combined height of the substrate 1, the circuit layout of electrode sets 11, the outer membrane 2, the conducting portion 21 and the electrically insulative beads 211; because the invention eliminates the use of metal domes, rubber domes or scissor-type linking elements and because the height of the electrically insulative beads 211 is much smaller than the distance of movement of a metal dome, rubber dome or scissor-type linking element, the thickness and number of component parts of the ultra-thin computer input device can be greatly reduced.
3. A spacer layer 3 that has openings 31 for accommodating the electrically insulative beads 211 and conducting portions 21 of the outer membrane 2 can be provided between the substrate 1 and the outer membrane 2 to support the outer membrane 2 above the substrate 1 in shape without significantly increasing the total thickness of the ultra-thin computer input device, making a significant difference between touching the area of the outer member 2 corresponding to the conducting portions and the other area of the outer member 2 beyond the conducting portions 21.
4. A support layer 4 can be set between the substrate 1 and the spacer layer 3 to support the spacer layer 3 and the outer membrane 2 on the substrate 1, keeping the electrically insulative beads 211 of the outer membrane 2 in contact with the comb-like contact portions 113 of the first electrodes 111 and second electrodes 112 of the electrode sets 11 of the substrate 1 lightly, avoiding causing elastic fatigue of the electrically insulative beads 211 and prolonging the service life of the ultra-thin computer input device.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An ultra-thin computer input device, comprising:
a substrate carrying a circuit layout on a top surface, said circuit layout comprising a plurality of electrode sets raised to the top surface of said substrate, each said electrode set comprising a first electrode and a second electrode, said first electrode and said second electrode each comprising a comb-like contact portion, the comb-like contact portion of said first electrode facing toward the comb-like contact portion of said second electrode in such a manner that the two comb-like contact portions of said first electrode and said second electrode are disposed in a staggered manner with a plurality of gaps left therebetween; and an outer membrane arranged on said substrate over said circuit layout, said outer membrane comprising a plurality of conducting portions located on a bottom surface thereof corresponding to the comb-like contact portions of the first electrodes and second electrodes of said electrode sets of said circuit layout of said substrate, and a plurality of electrically insulative beads located on a part of a bottom side of each said conducting portion and stopped against the comb-like contact portions of the first electrodes and second electrodes of said electrode sets of said circuit layout of said substrate.

2. The ultra-thin computer input device as claimed in claim 1, wherein the comb-like contact portion of each of said first electrode and said second electrode comprises a plurality of fingers, the fingers of the comb-like contact portion of said first electrode and the fingers of the comb-like contact portion of said second electrode being disposed in a staggered manner with a gap left between each finger of the comb-like contact portion of said first electrode and each adjacent finger of the comb-like contact portion of said second electrode.

3. The ultra-thin computer input device as claimed in claim 1, wherein said outer membrane is selected from the group of flexible and elastic materials; said conducting portions of said outer membrane are made of an electrically conductive material selected from the group of carbon film, silver paste and copper foil; said electrically insulative beads of said membrane are made of an electrically insulative elastic material.

4. The ultra-thin computer input device as claimed in claim 1, further comprising a spacer layer set between said substrate and said outer membrane, said spacer layer comprising a plurality of openings for accommodating said electrically insulative beads and said conducting portions of said outer membrane.

5. The ultra-thin computer input device as claimed in claim 4, wherein said spacer layer is an one-piece sheet member sandwiched between said substrate and said outer membrane.

6. The ultra-thin computer input device as claimed in claim 4, wherein said spacer layer is formed of multiple strips adhered between said substrate and said outer membrane.

7. The ultra-thin computer input device as claimed in claim 4, further comprising a support layer set between said substrate and said spacer layer, said support layer comprising a plurality of openings corresponding to the openings of said spacer layer for accommodating the electrically insulative beads and conducting portions of said outer membrane.
